(19) United States
(12) Patent Application Publication
(10) Pub. No.: US 2025/0307571 A1
(43) Pub. Date: Oct. 2, 2025

(54) LARGE LANGUAGE MODEL-BASED TARGET SEQUENCE GENERATION METHOD, DEVICE AND MEDIUM

(71) Applicant: BAIDU ONLINE NETWORK TECHNOLOGY (BEIJING) CO., LTD., Beijing (CN)

(72) Inventors: Jingbo ZHOU, Beijing (CN); Deqiang HUANG, Beijing (CN); Xinjiang LU, Beijing (CN); Tong XU, Beijing (CN)

(73) Assignee: BAIDU ONLINE NETWORK TECHNOLOGY (BEIJING) CO., LTD., Beijing (CN)

(21) Appl. No.: 19/239,808

(22) Filed: Jun. 16, 2025

(30) Foreign Application Priority Data
Dec. 16, 2024 (CN) 202411855816.2

(51) Int. Cl. G06F 40/40; G06F 16/215

(52) U.S. Cl. CPC G06F 40/40; G06F 16/215

(57) ABSTRACT

A large language model-based target sequence generation method, which belongs to the field of artificial intelligence technology, specifically to the fields of large language models, natural language processing, deep learning and other technologies are provided. The large language model-based target sequence generation method includes: determining quality scores of candidate paths corresponding to candidate sequence elements based on prediction probabilities of the candidate sequence elements obtained by a large language model; pruning the candidate paths based on the quality scores to obtain one or more pruned paths; determining a target search width based on the prediction probabilities, and determining one or more target sequence elements from one or more candidate sequence elements corresponding to the one or more pruned paths according to the target search width; and generating one or more target sequences based on the one or more target sequence elements.

### CROSS-REFERENCE TO RELATED APPLICATION

The present disclosure claims the priority and benefit of Chinese Patent Application No. 202411855816.2, filed on Dec. 16, 2024. The disclosure of the above application is incorporated herein by reference in its entirety.

### TECHNICAL FIELD

The present disclosure relates to the field of artificial intelligence technology, particularly to the fields of large language models, natural language processing, deep learning and other technologies, and more particularly to a large language model-based target sequence generation method, device and medium.

### BACKGROUND

Artificial Intelligence Generated Content (AIGC) refers to the technology that generates relevant content with appropriate generalization capability through learning and recognition of existing data, based on artificial intelligence technologies such as generative adversarial networks and large pre-trained models.

One application scenario of AIGC is sequence generation, where the goal of a sequence generation task is to generate an ordered sequence.

In practical application scenarios, how to efficiently generate high-quality sequences is a problem that needs to be solved.

### SUMMARY

The present disclosure provides a large language model-based target sequence generation method, device and medium.

According to one aspect of the present disclosure, a large language model-based target sequence generation method is provided, which includes: determining quality scores of candidate paths corresponding to candidate sequence elements based on prediction probabilities of the candidate sequence elements; pruning the candidate paths based on the quality scores to obtain one or more pruned paths; determining a target search width based on the prediction probabilities, and determining one or more target sequence elements from one or more candidate sequence elements corresponding to the one or more pruned paths according to the target search width; and generating one or more target sequences based on the one or more target sequence elements.

According to another aspect of the present disclosure, an electronic device is provided, which includes: at least one processor; and a memory communicatively connected to the at least one processor; where the memory stores instructions executable by the at least one processor to cause the at least one processor perform the method according to any of the above aspects.

According to another aspect of the present disclosure, a non-transitory computer-readable storage medium storing computer instructions is provided, where the computer instructions are used to cause the computer to perform the method according to any of the above aspects.

It should be understood that the content described in this section is not intended to identify key or essential features of the embodiments of the present disclosure, nor is it intended to limit the scope of the present disclosure. Other features of the present disclosure will become readily understandable through the following specification.

### BRIEF DESCRIPTION OF THE DRAWINGS

The drawings are used for better understanding the present solution and do not constitute a limitation of the present disclosure. In the drawings,

FIG. 1 is a schematic diagram according to a first embodiment of the present disclosure;

FIG. 2 is a schematic diagram of an application scenario for implementing an embodiment of the present disclosure;

FIG. 3 is a schematic diagram according to a second embodiment of the present disclosure;

FIG. 4 is a schematic diagram according to a third embodiment of the present disclosure; and

FIG. 5 is a schematic diagram of an electronic device for implementing the large language model-based target sequence generation method according to embodiments of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In related technologies, greedy algorithms or fixed search width algorithms may be used to generate sequences.

However, greedy algorithms tend to fall into local optima, resulting in poor quality of generated sequences. For fixed search width algorithms, if the width is set too large, it will reduce generation efficiency, and if the width is set too small, accuracy will be affected. Therefore, sequence generation algorithms in related technologies cannot effectively balance efficiency and quality.

To generate sequences efficiently and with high quality, the present disclosure provides the following embodiments.

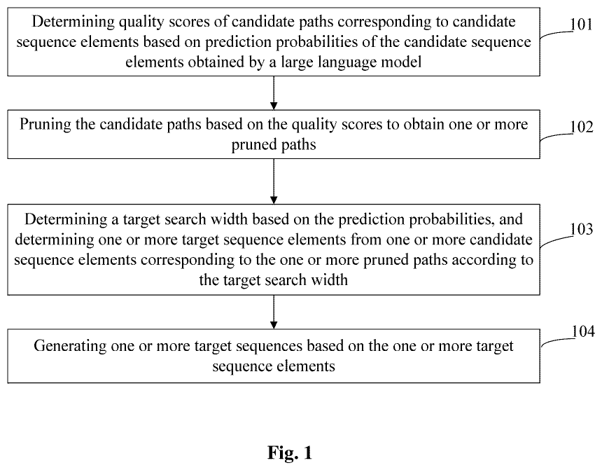

FIG. 1 is a schematic diagram according to a first embodiment of the present disclosure. This embodiment provides a large language model-based target sequence generation method, as shown in FIG. 1, the method includes:

101. Determining quality scores of candidate paths corresponding to candidate sequence elements based on prediction probabilities of the candidate sequence elements obtained by a large language model.

102. Pruning the candidate paths based on the quality scores to obtain one or more pruned paths.

103. Determining a target search width based on the prediction probabilities, and determining one or more target sequence elements from one or more candidate sequence elements corresponding to the one or more pruned paths according to the target search width.

104. Generating one or more target sequences based on the one or more target sequence elements.

The executing subject of the large language model-based target sequence generation method in this embodiment is a large language model-based target sequence generation apparatus, which may be an independent electronic entity or a software-integrated application running on devices such as computers to implement the target sequence generation method.

The sequence elements refers to the elements that compose a sequence. For example, in a text generation scenario, sequence elements are words; in a map navigation route planning scenario, sequence elements are routes; in a problem-solving scenario, sequence elements are solving steps.

A candidate sequence element is a selectable sequence element. For example, in a text generation scenario, 1000 words can be pre-configured as candidate sequence elements.

A target sequence element refers to a sequence element selected from candidate sequence elements.

A prediction probability is used to represent the probability of a candidate sequence element being selected. The higher the prediction probability, the higher the probability that the corresponding candidate sequence element will be selected as the target sequence element.

The prediction probability may be obtained by an Artificial Intelligence (AI) model.

Generally, during AI model processing, the prediction probability of each candidate sequence element is obtained through a normalization function, such as a softmax function. Therefore, this prediction probability may also be called softmax probability.

The AI model may be a model specifically designed for sequence generation, or the AI model may be a large model.

A large model refers to a Large Language Model (LLM), which is a hot technology in the AI field in recent years. LLM is a natural language processing model based on deep learning, which has a huge number of parameters and complex structure, enabling it to process and understand large amounts of natural language data. Through pre-training and fine-tuning processes, LLM models can perform excellently in various natural language processing tasks, including but not limited to text generation, language understanding, machine translation, etc.

For models specifically designed for sequence generation, information can be pre-configured to control operations such as pruning and search width adjustment.

For large language models, which execute related operations based on prompt information, pruning operation rules and search width adjustment rules can be included in the prompt information to instruct the large language model to execute operations such as pruning and search width adjustment.

In sequence generation tasks, typically the next element is predicted based on the current input, then the generated element is used as new input to continue generating a new element, and this cycle continues until a sequence meeting a preset requirement (such as preset length) is generated.

Therefore, each generation moment (generation step) can be treated as the current moment, the prediction probabilities of candidate sequence elements at the current moment are obtained, and one or more target sequence elements are determined from the candidate sequence elements at the current moment.

Elements generated at different moments (generation steps) can form a path. For example, if a first element is predicted at a first moment, a second element is predicted at a second moment, and a third element is predicted at a third moment, then the path at the first moment includes the first element, the path at the second moment includes the first and second elements, and the path at the third moment includes the first, second, and third elements.

A candidate path refers to a path corresponding to a candidate sequence element. For example, if elements A and B have been predicted before the current moment, and the current candidate sequence elements include C1, C2, and C3, then A, B, C1 form one candidate path, which can be expressed as A-B-C1; A, B, C2 form another candidate path, which can be expressed as A-B-C2; A, B, C3 form another candidate path, which can be expressed as A-B-C3.

A quality score is used to characterize the quality of a candidate path. The higher the quality score, the higher the quality of the corresponding path, and the lower the quality score, the lower the quality of the corresponding path.

The quality score of each candidate path can be obtained from the prediction probabilities of its corresponding elements, for example, by calculating the mean of the prediction probabilities of its elements. For example, for the candidate path A-B-C1, the quality score can be obtained by adding the prediction probabilities of element A, element B, and element C1.

After obtaining the quality score, pruning may be performed according to the quality score. For example, when the quality score of a candidate path is less than a preset score, that candidate path is pruned, meaning it is deleted. For another example, if the quality score of candidate path A-B-C1 is less than the preset score, that path is deleted. Conversely, if the quality score is not less than the preset score, the candidate path is retained.

After pruning the candidate paths, the remaining path(s) can be called pruned path(s). For the above example, the pruned paths include: A-B-C2 and A-B-C3.

After obtaining the pruned paths, one or more target sequence elements can be determined from their corresponding candidate sequence elements according to a search width. For the above example, the target sequence element can be determined in C2 and C3. Specifically, a number of candidate sequence element(s) equal to the search width is selected, in descending order of prediction probability, as target sequence element(s). For example, if the search width B=1, and assuming the prediction probability of C2 is higher than predication probability of C3, then the target sequence element at the current moment is C2.

The target search width is the search width used at the current moment. The target search width is determined based on the aforementioned prediction probabilities, enabling dynamic adjustment of the search width rather than using a fixed value, thus avoiding the problem of inability to balance efficiency and quality caused by fixed search width.

After obtaining the one or more target sequence elements, the target sequence elements from different moments can be combined to obtain one or more target sequences.

For example, if a sequence of length 3 is to be generated, and the target sequence elements at different moments are A, B, and C2, then the final generated target sequence includes: A, B, and C2.

In this embodiment, pruning candidate path(s) with quality scores below the preset score can remove low-quality candidate path(s), improving processing efficiency; determining target search width based on prediction probabilities enables dynamic adjustment of search width, effectively balancing quality and efficiency. Therefore, sequences can be generated efficiently and with high quality.

In terms of specific data forms, a target sequence may be data of various modalities, such as a text sequence. That is, the large language model may obtain candidate text elements according to text prompt information, obtain target text elements from candidate text elements, and compose target text sequence(s) based on target text elements. Such text may include words, numbers, symbols, and other content.

The above uses text sequence generation as an example. It should be understood that the method can also be used for sequence generation of other forms of data, such as audio sequences, video sequences, image sequences generations, etc.

Specific scenarios include route generation scenarios where the generated target sequences are route sequences, or customer service scenarios where the generated target sequences consists of problem-solving steps, etc.

For better understanding of the present disclosure, the application scenarios involved are explained as follows:

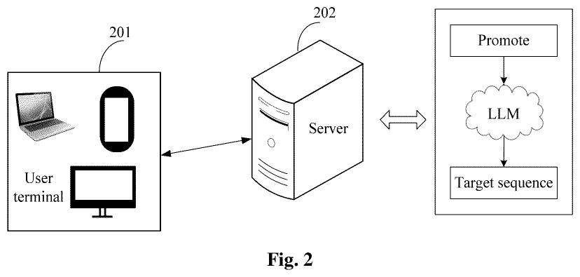

FIG. 2 is a schematic diagram of an application scenario for implementing an embodiment of the present disclosure.

This embodiment takes the AI model as a large language model as an example.

The large language model executes operations based on prompt information.

As shown in FIG. 2, a user sends prompt information to the server through the client. The prompt information includes initial information. The initial information may be preset values, such as preset start symbols; the initial information may also be requirement information for the target sequence, such as generating a navigation route between location points X and Y. To help the large language model better understand the requirements, route examples may also be provided. For efficient and high-quality sequence generation, the prompt information may also instruct the large language model to perform operations such as pruning and search width adjustment, accordingly, the prompt information may also include a pruning rule, a search width adjustment rule, etc., as well as a threshold involved in the rules, such as a preset score, an uncertainty threshold, etc., where the preset score is used for pruning and the uncertainty threshold is used for adjusting the search width.

The client is deployed on user terminal 201, which may include: Personal Computer (PC), laptop, mobile phone and other mobile devices, while the server is deployed on server 202, which may be a local server or a cloud server, either a single server or server cluster.

The server is a sequence generation task-related server, such as a map server, which can call the large language model. Thus, after receiving the prompt information, the server sends it to the large language model, which generates sequences based on the prompt information to obtain a target sequence.

After the target sequence is obtained by the large language model, it can be sent to the client via the server and displayed to the user through the client, so the user can obtain the needed sequence, such as a navigation route.

For the above application scenario, the present disclosure further provides the following embodiment.

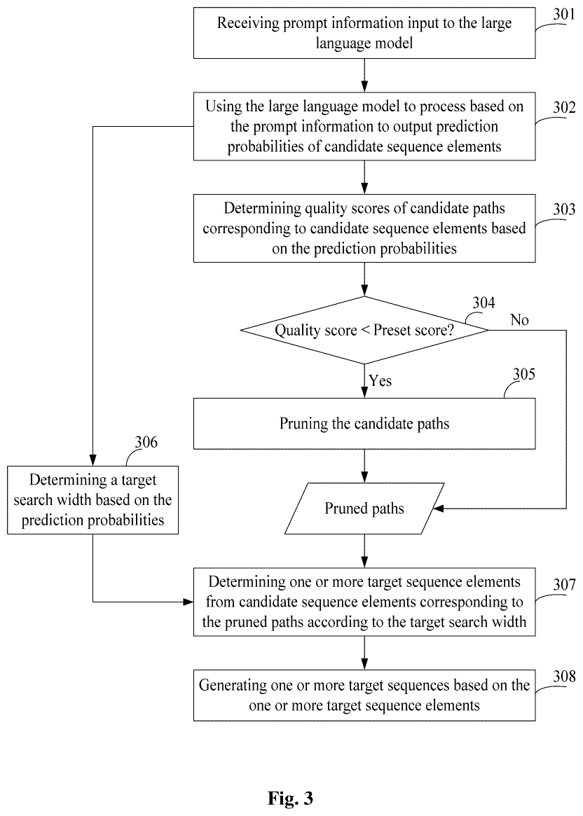

FIG. 3 is a schematic diagram according to a second embodiment of the present disclosure, which provides a large language model based target sequence generation method.

This embodiment takes the AI model as a large language model as an example. As shown in FIG. 3, the method includes:

301. Receiving prompt information input to the large language model.

Where, the prompt information is used to instruct the large language model to perform sequence generation operation.

The prompt information contains initial information, which may be preset values, such as preset start symbols; the initial information may also be requirement information for the target sequence, such as generating a navigation route between location points X and Y. To help the large language model better understand the requirements, a route example may also be provided. For efficient and high-quality sequence generation, the prompt information may also instruct the large language model to perform operations such as pruning and search width adjustment, accordingly, the prompt information may also include a pruning rule, a search width adjustment rule, etc., as well as thresholds involved in the rules, such as a preset score, an uncertainty threshold, etc., where the preset score is used for pruning and the uncertainty threshold is used for adjusting the search width.

302. Using the large language model to process based on the prompt information to output prediction probabilities of candidate sequence elements.

303. Determining quality scores of candidate paths corresponding to candidate sequence elements based on the prediction probabilities.

Where, accumulating the prediction probability of each of the candidate sequence elements and prediction probabilities of one or more historical sequence elements to obtain an accumulated value; the one or more historical sequence elements are elements preceding the candidate sequence elements on the candidate paths; obtaining a quality score based on the accumulated value.

Specifically, the mean of the accumulated value may be calculated and used as the quality score.

Expressed in formula:

$$Path\_Score = \frac{1}{N} {\sum }_{i = 1}^{N} P ( {y}_{i} \vert {y}_{< i} , x )$$

Where P(yᵢ|y_{<i},x) is the prediction probability of sequence element y; based on the preceding context y_{<i} and initial information x;
N is the number of elements on the candidate path.

For example, if the candidate sequence elements at the current moment include C1, and the historical sequence elements include A and B, then the quality score of candidate path A−B−C1=(P(A)+P(B)+P(C1))/3, where P(A), P(B), and P(C1) are the prediction probabilities of elements A, B, C1 respectively, and these prediction probabilities are obtained based on the preceding context and initial information (such as requirement information). For example, for A, its preceding context is empty; for B, its preceding context is A; for C1, its preceding context is A and B.

In this embodiment, determining the quality score based on the accumulated prediction probabilities of elements on a candidate path can consider information from each element, improving the accuracy of the quality score and thereby improving the accuracy of sequence generation.

304. Determining whether the quality score is less than the preset score, if yes, executing 305, otherwise retaining the candidate path as a pruned path.

305. Pruning the candidate paths to obtain pruned paths.

306. Determining a target search width based on the prediction probabilities.

Where, an uncertainty parameter may be obtained based on the prediction probabilities, where the uncertainty parameter is used to characterize the uncertainty of candidate paths; the target search width is determined based on the uncertainty parameter.

Specifically, the uncertainty parameter can be a distribution entropy or variance.

Taking distribution entropy as an example, the calculation formula can be:

$$U = - {\sum }_{j = 1}^{M} P ( {y}_{j} ) log ( P ( {y}_{j} ) )$$

Where U is the uncertainty parameter;
P(yⱼ) is the candidate sequence element at the current moment;
M is the number of candidate sequence elements at the current moment.

When the uncertainty parameter U is greater than or equal to the preset threshold, increase the search width, otherwise, decrease the search width. That is, in response to the uncertainty parameter being greater than or equal to the preset threshold, determine the target search width as a first value; or, in response to the uncertainty parameter being less than the preset threshold, determine the target search width as a second value; where the first value is greater than the second value.

Specifically, increasing or decreasing the search width may be based on the search width used in the previous moment. For example, if the search width used in the previous moment was B0=2, then when U is greater than or equal to the preset threshold, the target search width for the current moment may be set as B=3; when U is less than the preset threshold, B may be set as 1. Additionally, taking the example of decreasing search width when U is small, the search width may also be kept unchanged, such as maintaining B=2 when U is less than the preset threshold.

Increasing or decreasing the search width may also be done by directly setting it to a maximum value or a minimum value. For example, when U is greater than or equal to the preset threshold, the target search width at the current moment can be set as B=Bₘₐₓ, and when U is less than the preset threshold, the target search width at the current moment can be set as B=Bₘᵢₙ. The initial search width can be set as Bₘᵢₙ. Where Bₘₐₓ and Bₘᵢₙ are preset maximum and minimum widths.

Taking setting the target search width as maximum or minimum width as an example, expressed in formula:

$$B = \{ \begin{matrix}{B}_{m ax} & if U \geq {U}_{thresh} \\ {B}_{m i n} & if U < {U}_{thresh}\end{matrix}$$

Where B is the target search width;
Bₘₐₓ is the maximum width, Bₘᵢₙ is the minimum width, both are preset values;
U thresh is the preset threshold.

307. Determining one or more target sequence elements from candidate sequence elements corresponding to the pruned paths according to the target search width.

Where, the target search width represents the number of target sequence elements. For example, if target search width B=2, then select 2 candidate sequence elements with higher prediction probabilities as target sequence elements. For instance, if candidate sequence elements corresponding to pruned paths include C2, C3, C4, and both C2 and C4 have higher prediction probabilities than C3, then C2 and C4 are selected as the target sequence elements.

308. Generating one or more target sequences based on the one or more target sequence elements.

Where, target sequence elements from different moments can be combined to obtain the one or more target sequences.

In this embodiment, determining the target search width based on an uncertainty parameter enables dynamic adjustment of the target search width according to candidate path conditions, effectively balancing quality and efficiency.

Using distribution entropy or variance as an uncertainty parameter enables efficient and convenient obtaining of the uncertainty parameter, improving sequence generation efficiency.

By setting a larger target search width when the uncertainty parameter is greater than or equal to a preset threshold, and a smaller target search width otherwise, the search range can be expanded when candidate paths have high uncertainty to improve search quality, and reduced when candidate paths have high certainty to improve search efficiency, thereby effectively improving sequence generation quality and efficiency.

Setting target search width to a preset maximum or a minimum width simplifies operations, improves processing efficiency, and saves resources.

In this embodiment, performing sequence generation operations through large language models can utilize their excellent performance without additional training, improving adaptability and universality.

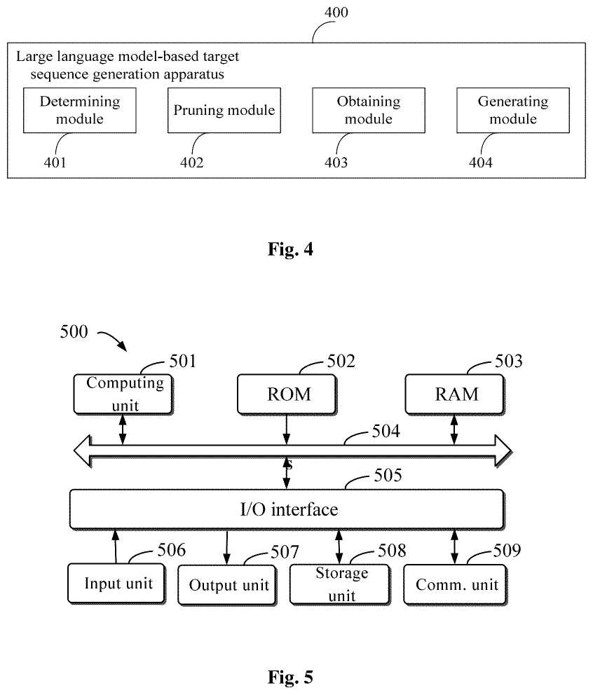

FIG. 4 is a schematic diagram according to a third embodiment of the present disclosure, which provides a large language model-based target sequence generation apparatus. The apparatus 400 includes: a determining module 401, a pruning module 402, an obtaining module 403, and a generating module 404.

The determining module 401 is configured to determine quality scores of candidate paths corresponding to candidate sequence elements based on prediction probabilities of candidate sequence elements; the pruning module 402 is configured to prune candidate paths based on quality scores to obtain one or more pruned paths; the obtaining module 403 is configured to determine a target search width based on prediction probabilities and determine one or more target sequence elements from one or more candidate sequence elements corresponding to the one or more pruned paths according to the target search width; and the generating module 404 is configured to generate one or more target sequences based on the one or more target sequence elements.

In this embodiment, pruning a candidate path with quality score below a preset score can remove a low-quality candidate path, improving processing efficiency; determining a target search width based on prediction probabilities enables dynamic adjustment of search width, effectively balancing quality and efficiency. Therefore, sequences can be generated efficiently and with high quality.

In some embodiments, the determining module 401 is further configured to:

Accumulate the prediction probability of each of the candidate sequence elements and prediction probabilities of one or more historical sequence elements to obtain an accumulated value; the one or more historical sequence elements are elements preceding the candidate sequence elements on the candidate paths;

Obtain a quality score based on the accumulated value.

In this embodiment, determining quality scores based on accumulated prediction probabilities of elements on candidate paths can consider information from each element, improving accuracy of quality scores and thereby improving accuracy of sequence generation.

In some embodiments, the obtaining module 403 is further configured to:

Obtain an uncertainty parameter based on the prediction probabilities, where the uncertainty parameter is used to characterize uncertainty of candidate paths;

Determine the target search width based on the uncertainty parameter.

In this embodiment, determining the target search width based on the uncertainty parameter enables dynamic adjustment of the target search width according to candidate path conditions, effectively balancing quality and efficiency.

In some embodiments, the obtaining module 403 is further configured to:

Calculate a distribution entropy or variance based on the prediction probabilities, and use the distribution entropy or variance as the uncertainty parameter.

In this embodiment, using the distribution entropy or variance as the uncertainty parameter enables efficient and convenient obtaining of the uncertainty parameter, improving sequence generation efficiency.

In some embodiments, the obtaining module 403 is further configured to:

In response to the uncertainty parameter being greater than or equal to a preset threshold, determine the target search width as a first value; or

In response to the uncertainty parameter being less than the preset threshold, determine the target search width as a second value;

Where the first value is greater than the second value.

In this embodiment, setting a larger target search width when the uncertainty parameter is greater than or equal to the preset threshold, and setting a smaller target search width otherwise, enables expanding the search range when the candidate paths have high uncertainty to improve search quality, and reducing the search range when the candidate paths have high certainty to improve search efficiency, thereby effectively improving sequence generation quality and efficiency.

In some embodiments, the obtaining module 403 is further configured to:

In response to the uncertainty parameter being greater than or equal to the preset threshold, determine the target search width as a preset maximum width; or

In response to the uncertainty parameter being less than the preset threshold, determine the target search width as a preset minimum width.

In this embodiment, setting the target search width to the preset maximum or the minimum width simplifies operations, improves processing efficiency, and saves resources.

In some embodiments, the prediction probability is obtained by the large language model;

The apparatus 400 further includes:

A receiving module configured to receive prompt information input to the large language model, where the prompt information is used to prompt the large language model to perform a sequence generation operation.

In this embodiment, performing sequence generation operations through large language models can utilize the excellent performance of the large language models without additional training, improving adaptability and universality.

It should be understood that in the embodiments of the present disclosure, identical or similar content in different embodiments can be cross-referenced.

It should be understood that “first”, “second”, etc. in the embodiments of the present disclosure are only used for distinction and do not indicate importance level, temporal order, etc.

It should be understood that unless specially specified, the temporal relationship between steps in the process is not limited.

In the technical solutions of the present disclosure, the collection, storage, use, processing, transmission, provision and disclosure of user personal information comply with relevant laws and regulations and do not violate public order and good morals.

According to the embodiments of the present disclosure, the present disclosure also provides an electronic device, a readable storage medium and a computer program product.

FIG. 5 shows a schematic block diagram of an electronic device 500 which may be configured to implement the embodiment of the present disclosure. The electronic device 500 is intended to represent various forms of digital computers, such as laptop computers, desktop computers, workstations, servers, blade servers, mainframe computers, and other appropriate computers. The electronic device may also represent various forms of mobile devices, such as personal digital assistants, cellular telephones, smart phones, wearable devices, and other similar computing devices. The components shown herein, their connections and relationships, and their functions, are meant to be exemplary only, and are not meant to limit implementation of the present disclosure described and/or claimed herein.

As shown in FIG. 5, the device 500 includes a computing unit 501 which may perform various appropriate actions and processing operations according to a computer program stored in a read only memory (ROM) 502 or a computer program loaded from a storage unit 508 into a random access memory (RAM) 503. Various programs and data necessary for the operation of the device 500 may be also stored in the RAM 503. The computing unit 501, the ROM 502, and the RAM 503 are connected with one other through a bus 504. An input/output (I/O) interface 505 is also connected to the bus 504.

The plural components in the device 500 are connected to the I/O interface 505, and include: an input unit 506, such as a keyboard, a mouse, or the like; an output unit 507, such as various types of displays, speakers, or the like; the storage unit 508, such as a magnetic disk, an optical disk, or the like; and a communication unit 509, such as a network card, a modem, a wireless communication transceiver, or the like. The communication unit 509 allows the device 500 to exchange information/data with other devices through a computer network, such as the Internet, and/or various telecommunication networks.

The computing unit 501 may be a variety of general and/or special purpose processing components with processing and computing capabilities. Some examples of the computing unit 501 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 501 performs the methods and processing operations described above, such as the large language model-based target sequence generation method. For example, in some embodiments, the large language model-based target sequence generation method may be implemented as a computer software program tangibly contained in a machine readable medium, such as the storage unit 508. In some embodiments, part or all of the computer program may be loaded and/or installed into the device 500 via the ROM 502 and/or the communication unit 509. When the computer program is loaded into the RAM 503 and executed by the computing unit 501, one or more steps of the method according to the present disclosure may be performed. Alternatively, in other embodiments, the computing unit 501 may be configured to perform the large language model-based target sequence generation method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input device, and at least one output device.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing device (for example, a mouse or a trackball) by which a user may provide input for the computer. Other kinds of devices may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server, also known as cloud computing server or cloud host, is a host product in the cloud computing service system, to solve the traditional physical host and VPS service (“Virtual Private Server”, or referred to as “VPS”), in the management difficulty, weak business scalability defects. The server may also be a server for a distributed system, or a server that combines blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A large language model-based target sequence generation method, comprising:
determining quality scores of candidate paths corresponding to candidate sequence elements based on prediction probabilities of the candidate sequence elements obtained by a large language model;
pruning the candidate paths based on the quality scores to obtain one or more pruned paths;
determining a target search width based on the prediction probabilities, and determining one or more target sequence elements from one or more candidate sequence elements corresponding to the one or more pruned paths according to the target search width; and
generating one or more target sequences based on the one or more target sequence elements.

2. The method according to claim 1, wherein determining the quality scores of the candidate paths corresponding to the candidate sequence elements based on the prediction probabilities of the candidate sequence elements comprises:
accumulating the prediction probability of each of the candidate sequence elements and prediction probabilities of one or more historical sequence elements to obtain an accumulated value, wherein the one or more historical sequence elements are elements preceding the candidate sequence elements on the candidate paths; and
obtaining a quality score based on the accumulated value.

3. The method according to claim 1, wherein determining the target search width based on the prediction probabilities comprises:
obtaining an uncertainty parameter based on the prediction probabilities, wherein the uncertainty parameter is used to characterize uncertainty of the candidate paths; and
determining the target search width based on the uncertainty parameter.

4. The method according to claim 3, wherein obtaining the uncertainty parameter based on the prediction probabilities comprises:
calculating a distribution entropy or variance based on the prediction probabilities, and using the distribution entropy or variance as the uncertainty parameter.

5. The method according to claim 3, wherein determining the target search width based on the uncertainty parameter comprises:
in response to the uncertainty parameter being greater than or equal to a preset threshold, determining the target search width as a first value;
in response to the uncertainty parameter being less than the preset threshold, determining the target search width as a second value;
wherein the first value is greater than the second value.

6. The method according to claim 5, wherein
determining the target search width as the first value comprises: determining the target search width as a preset maximum width;
determining the target search width as the second value comprises: determining the target search width as a preset minimum width.

7. The method according to claim 1, further comprising:
receiving prompt information input to the large language model, wherein the prompt information is used to prompt the large language model to perform a sequence generation operation.

8. An electronic device, comprising:
at least one processor; and
a memory communicatively connected with the at least one processor;
wherein the memory stores instructions executable by the at least one processor to cause the at least one processor to perform a large language model-based target sequence generation method, comprising:
determining quality scores of candidate paths corresponding to candidate sequence elements based on prediction probabilities of the candidate sequence elements obtained by a large language model;
pruning the candidate paths based on the quality scores to obtain one or more pruned paths;
determining a target search width based on the prediction probabilities, and determining one or more target sequence elements from one or more candidate sequence elements corresponding to the one or more pruned paths according to the target search width; and
generating one or more target sequences based on the one or more target sequence elements.

9. The electronic device according to claim 8, wherein determining the quality scores of the candidate paths corresponding to the candidate sequence elements based on the prediction probabilities of the candidate sequence elements comprises:
accumulating the prediction probability of each of the candidate sequence elements and prediction probabilities of one or more historical sequence elements to obtain an accumulated value, wherein the one or more historical sequence elements are elements preceding the candidate sequence elements on the candidate paths; and
obtaining a quality score based on the accumulated value.

10. The electronic device according to claim 8, wherein determining the target search width based on the prediction probabilities comprises:
obtaining an uncertainty parameter based on the prediction probabilities, wherein the uncertainty parameter is used to characterize uncertainty of the candidate paths; and
determining the target search width based on the uncertainty parameter.

11. The electronic device according to claim 10, wherein obtaining the uncertainty parameter based on the prediction probabilities comprises:
calculating a distribution entropy or variance based on the prediction probabilities, and using the distribution entropy or variance as the uncertainty parameter.

12. The electronic device according to claim 10, wherein determining the target search width based on the uncertainty parameter comprises:
in response to the uncertainty parameter being greater than or equal to a preset threshold, determining the target search width as a first value;
in response to the uncertainty parameter being less than the preset threshold, determining the target search width as a second value;
wherein the first value is greater than the second value.

13. The electronic device according to claim 12, wherein
determining the target search width as the first value comprises: determining the target search width as a preset maximum width;
determining the target search width as the second value comprises: determining the target search width as a preset minimum width.

14. The electronic device according to claim 8, wherein the method further comprises:
receiving prompt information input to the large language model, wherein the prompt information is used to prompt the large language model to perform a sequence generation operation.

15. A non-transitory computer-readable storage medium storing computer instructions for causing a computer to perform a large language model-based target sequence generation method, comprising:
determining quality scores of candidate paths corresponding to candidate sequence elements based on prediction probabilities of the candidate sequence elements obtained by a large language model;
pruning the candidate paths based on the quality scores to obtain one or more pruned paths;
determining a target search width based on the prediction probabilities, and determining one or more target sequence elements from one or more candidate sequence elements corresponding to the one or more pruned paths according to the target search width; and
generating one or more target sequences based on the one or more target sequence elements.

16. The storage medium according to claim 15, wherein determining the quality scores of the candidate paths corresponding to the candidate sequence elements based on the prediction probabilities of the candidate sequence elements comprises:
accumulating the prediction probability of each of the candidate sequence elements and prediction probabilities of one or more historical sequence elements to obtain an accumulated value, wherein the one or more historical sequence elements are elements preceding the candidate sequence elements on the candidate paths; and
obtaining a quality score based on the accumulated value.

17. The storage medium according to claim 15, wherein determining the target search width based on the prediction probabilities comprises:
obtaining an uncertainty parameter based on the prediction probabilities, wherein the uncertainty parameter is used to characterize uncertainty of the candidate paths; and
determining the target search width based on the uncertainty parameter.

18. The storage medium according to claim 17, wherein obtaining the uncertainty parameter based on the prediction probabilities comprises:
calculating a distribution entropy or variance based on the prediction probabilities, and using the distribution entropy or variance as the uncertainty parameter.

19. The storage medium according to claim 17, wherein determining the target search width based on the uncertainty parameter comprises:
in response to the uncertainty parameter being greater than or equal to a preset threshold, determining the target search width as a first value;
in response to the uncertainty parameter being less than the preset threshold, determining the target search width as a second value;
wherein the first value is greater than the second value.

20. The storage medium according to claim 19, wherein
determining the target search width as the first value comprises: determining the target search width as a preset maximum width;
determining the target search width as the second value comprises: determining the target search width as a preset minimum width.
